(19) United States
(12) Patent Application Publication
(10) Pub. No.: US 2016/0256934 A1
(43) Pub. Date: Sep. 8, 2016

(54) ULTRA-LIGHTWEIGHT CLAMPING DEVICE

(71) Applicant: Roehm GmbH, Sontheim/Brenz (DE)

(72) Inventor: Eduard SCHWEIGERT, Syrgenstein (DE)

(73) Assignee: Roehm GmbH, Sontheim/Brenz (DE)

(21) Appl. No.: 15/061,354

(22) Filed: Mar. 4, 2016

(30) Foreign Application Priority Data
Mar. 4, 2015 (DE) 10 2015 103 122.1

(51) Int. Cl. B23B 31/02

(52) U.S. Cl. CPC B23B 31/02; B33Y 80/00

(57) ABSTRACT

A clamping device for clamping a workpiece, having a base body and at least one clamp which is adjustable relative to the base body, at least one cavity is formed in the base body, a reinforcement is formed in the cavity.

This nonprovisional application claims priority under 35 U.S.C. §119(a) to German Patent Application No. 10 2015 103 122.1, which was filed in Germany on Mar. 4, 2015, and which is herein incorporated by reference.

### BACKGROUND OF THE INVENTION

1. Field of the Invention

The invention relates to a clamping device for clamping a workpiece, comprising a base body and at least one clamp that is adjustable relative to the base body.

2. Description of the Background Art

Clamping devices of this type are known from practice, these clamping devices being characterized by an extremely massive design to achieve a high load tolerance, i.e. they are associated with a high weight. Due to the massive construction, vibrations are conducted undamped within the base body of the clamping device and are transmitted to the workpiece. This results in a higher wear on the clamping device and can limit the processing or transport of sensitive workpieces.

In chucks, the high weight also has the disadvantage that the rotational speed to be reached is dependent on the moment of inertia and thus on the mass of the chuck or the mass distribution within the chuck. The maximum power or the maximum rotational speed to be reached is thus limited, among other things, by the mass of the clamping devices.

### SUMMARY OF THE INVENTION

It is therefore an object of the invention to provide a clamping device such that an increase in power is achieved, while maintaining a high load tolerance.

According to an exemplary embodiment of the invention, this object is achieved in a clamping device of the type mentioned at the outset by the fact that at least one cavity is formed in the base body, and a reinforcement by compartmentalization is formed in the cavity. Forming at least one cavity causes a reduction in the weight of the clamping device. In a chuck, for example, the maximum rotational speed to be achieved may thus be increased on the basis of the reduced moment of inertia, whereby, among other things, shorter cycle times are achieved during manufacturing when using the chuck. To be able to continue guaranteeing a high load tolerance and thus a long life of the clamping device, a reinforcement by compartmentalization is formed in the cavity. The compartmentalization furthermore results in a low weight and makes it possible to damp vibrations in the base body. Within the scope of the invention, for example, multiple cavities are formed in the base body, and that at least one of the cavities has a reinforcement by compartmentalization. It is provided, in principle, that the volume part of the base body which is not heavily loaded during use of the clamping device is provided in the form of one or multiple cavities. The clamping device may be designed, for example, as a chuck, as a gripper or as a vise.

In principle, it is possible to form the cavities in the base body by bores by milling or other processes; however, it is particularly preferred within the scope of the invention that the base body is formed in layers, using an additive manufacturing process. The formation of the base body using an additive manufacturing process has the advantage that all basic structures relevant for the function of the clamping device may be combined in a 3D model and may be manufactured in one manufacturing step. The conventional manufacturing of a clamping device, on the other hand, comprises multiple manufacturing steps. At the same time, it is possible to integrate additional functions into the base body by an additive manufacturing process, as well as to individually adapt the design of the base body to the imposed requirements. In this connection, for example, the base body can be formed in layers by laser beam melting. However, other additive manufacturing methods, such as laser sintering and electron beam melting, are also possible. It is furthermore advantageous if the basic structures of the base body are manufactured to be preferably flat, since the manufacturing costs in additive manufacturing processes depend on the height of the piece to be manufactured. In this connection, it is also conceivable to form the base body not as a single part but in multiple parts for the purpose of connecting the individual parts to each other in another manufacturing step (for example, by welding). It is also favorable if the base body is made from a material which is selected from the group of high grade steel, aluminum, aluminum alloys, tool steel, titanium, titanium alloys, chromium-cobalt-molybdenum alloys, bronze alloys, noble metal alloys, nickel-base alloys, ceramics, plastic and Inconel. It is exceptionally preferred if the base body is made from titanium.

It has furthermore been proven to be favorable that the base body is delimited on the edge by an outer wall and has a base plate on which an inner wall is disposed for delimiting the at least one cavity. This results in an additional stabilization of the base body and makes it easier to form the reinforcement by compartmentalization in the cavity.

In an embodiment, the reinforcement by compartmentalization can be formed by a metal foam. The cavities are additionally stabilized thereby and thus made more resistant, a considerable reduction in weight compared to conventional clamping devices being achieved at the same time, due to the pores present in the metal foam. As a result, a reduction in the weight of the clamping device, and simultaneously a high load tolerance and thus a longer life, are achieved by forming the cavities and filling them with metal foam. In this connection, it is provided that the metal foam is formed from a foaming agent-activatable metal powder, the metal powder being selected from the group of aluminum, aluminum alloys, copper, zinc, lead, steel, titanium and iron. It is particularly preferred to use the combination of aluminum as the metal and titanium hydride as the foaming agent, due to the low weight. The aluminum and the titanium hydride are compressed into small metal plates and filled into the existing cavities. The aluminum foam is produced in the cavities by heating the clamping device to a temperature of approximately 500° C. In doing so, preferably uniform pores are expediently achieved during manufacturing. This plays a role, in particular, in round, rotating base bodies, to obtain a rotational symmetry of the base body. In this connection, it is provided that the surface of the base body is leveled and, in the case of round base bodies, balanced.

Alternatively, it is provided that the reinforcement is formed by a structure connected to the inner wall. The formation of a structure has the advantage that the reinforcement may be formed in the same manufacturing step as the layered production of the base body by the additive manufacturing process. Similarly to the advantages which may be achieved through the use of metal foam, the cavities are stabilized by the formation of a structure therein, and the clamping device is thus more load-tolerant, while the weight of the clamping device is simultaneously reduced. The structure may be formed, for example, by a honeycomb structure or a bionic structure. A honeycomb structure may be understood to be a regular, symmetrical structure similar to a bee honeycomb, although other shapes such as round or asymmetrical shapes are possible, and a mixture of different shapes is also conceivable. The formation of the structure may be individually adapted to the forces acting upon the cavity.

The clamping device is designed as a chuck, and the base body can be designed as the chuck body, including a spindle receptacle and including at least two guide receptacles, distributed evenly around the circumference and delimited by the inner wall, for the purpose of adjusting clamping jaws, and the at least one cavity is formed between the outer wall and the inner wall. Particularly in the case of chucks, the reduction in the weight of the base body, effected by the formation of the cavity, results in an increase in the power of the chuck, since higher maximum rotational speeds may be achieved. It is possible to form an arbitrary number of cavities between the outer wall and the inner wall, which are separated from each other by the inner wall. It is conceivable that the reinforcement is formed in at least one of the cavities. However, it is particularly preferred if the reinforcement is formed in all cavities. It should be kept in mind that, in round base bodies, i.e., in the case of chucks, the cavities between the inner wall and the outer wall must be disposed rotationally symmetrically. In one specific embodiment, in which not all cavities have a reinforcement, a rotational symmetry must also be maintained.

Two diametrically opposed guide surfaces can be assigned to each guide receptacle if the chuck comprises a first line system for lubrication, including a central line running in the circumferential direction, if a feed line connected to the central line is assigned to each guide surface, which has a lubrication opening which is open in the direction of the guide receptacle. This system facilitates a continuous lubrication of the clamping jaws. whereby the clamping force of the chuck is increased and signs of wear are reduced.

Due to the formation of the base body by an additive manufacturing method, many different arrangements and designs of the line system are possible. It is particularly preferred if the central line is guided in the circumferential direction along the outer wall of the base body. It is furthermore provided within the scope of the invention that the feed line is branched into a plurality of lubrication openings. It is particularly advantageous if the feed line runs parallel to the guide surface, and the lubrication openings are formed at regular intervals from each other. This facilitates a particularly even lubrication of the guide receptacle and the clamping jaws, whereby higher clamping forces may be achieved and wear may be reduced. At the same time, the base body has only one central lubricating nipple in an easily accessible location. This makes it significantly easier to maintain the chuck.

A radially inner reservoir, connected to the feed line, is assigned to each guide surface. It is provided that each reservoir is connected to a first feed line, which leads to the lubrication opening, and is also connected to a second feed line, which leads to the central line. The reservoir is disposed radially on the inside of the passage. The formation of inner reservoirs has the advantage that, upon rotation of the chuck, the lubricating fluid is pressed outwardly due to the centrifugal force, i.e., the lubricating fluid automatically passes from the inner reservoir to the lubrication openings via the feed lines. This automatic lubrication of the guide receptacle and clamping jaws thus increases the clamping force and reduces wear. It is particularly preferred if the reservoir is fillable. For this purpose, an access opening is mounted on the outer wall, which is connected to the central line. Alternatively, it is conceivable, in the first line system, to separately assign each guide surface a feed line having a lubrication opening, which is open in the direction of the guide receptacle and is connected to the reservoir. The feed line has an access opening on the outer wall. A central line running in the circumferential direction is not provided.

Within the scope of the invention, it is furthermore preferred that each guide receptacle is tangentially assigned a wedge bar receptacle, including a wedge bar, which is delimited by the inner wall and is movable along two diametrically opposed wedge bar guide surfaces, each wedge bar receptacle being assigned a wedge bar lubrication line, which is connected to the central line and has at least one wedge bar lubrication opening, which is open in the direction of the wedge bar receptacles. The wedge bars are in contact with the clamping jaws, whereby an easy and effective type of adjustment of the clamping jaws is achieved. The chuck may be designed as a two-jaw system or a three-jaw system. The wedge bar lubrication line and the wedge bar lubrication opening facilitate a continuous lubrication of the wedge bars, which results in a higher clamping force and lower wear. It has furthermore proven to be favorable that the wedge bar lubrication line is branched in a plurality of wedge bar lubrication openings, and the wedge bar lubrication line is guided in parallel to the diametrically opposed wedge bar guide surfaces in the wedge bar receptacle. In one alternative specific embodiment, it is also possible to provide a separate wedge bar lubrication line, which is not connected to the central line.

It is also advantageous if the chuck body comprises a second line system for cleaning, including a central channel running in the circumferential direction, each guide surface being assigned a supply channel, which is connected to the central channel and has a cleaning opening which opens in the direction of the guide receptacle. A cleaning of the guide surfaces and guide receptacle is made possible by the second line system. In this connection, it is particularly advantageous if the cleaning takes place using compressed air and the radius of the central channel and the supply channel is smaller than the radius of the central line and the feed line. As a result, the cleaning can take place under higher pressure. It is also provided that a cleaning channel opening is mounted on the outer wall, which is connected to the central channel. This facilitates a particularly easy access to the second line system. In one alternative specific embodiment, it is also provided that more than two line systems are formed. At the same time, the at least two line systems may be arbitrarily guided or formed in the chuck using the additive manufacturing process. It is particularly preferred if the central channel runs along the outer wall in the circumferential direction. The central line and the central channel are disposed on the outer wall of the base body in layers, one on top of the other. In other words, the base body or the chuck may also comprise a first line system (lubrication line system) and/or a second line system (cleaning line system).

In an embodiment, the supply channel can be branched into a plurality of cleaning openings. This permits a particularly effective cleaning of the guide surfaces and a particularly easy maintenance of the clamping device.

In an embodiment, the clamping device can be designed as a gripper, the base body having a cuboid shape, including cylinder chambers formed in the base body and delimited by an inner wall, and the at least one cavity being disposed between the outer wall and the inner wall. Due to the formation of at least one cavity, a weight reduction is also achieved with the gripper, the gripper continuing to have a high load tolerance and stability, due to the formation of the reinforcement in the cavities. At the same time, the vibrations transmitted in the base body are damped during use of the gripper, whereby even pieces which are sensitive to mechanical stresses may be gripped by the gripper. In particular, it is provided that multiple cavities are formed between the inner wall and the outer wall, which are filled by the reinforcement by compartmentalization and which are separated from each other by inner walls. It is furthermore provided that not every cavity must include the reinforcement (the metal foam or the structure). However, it is particularly preferred if the reinforcement is formed in each cavity. It is furthermore favorable if cavities are formed between the inner wall and the outer wall in the base body of the gripper wherever the surfaces or the volumes are subjected only to low stresses, i.e., weak forces. Within the scope of the invention, it is furthermore provided that the cylinder chambers are formed by a piston rod opening, including a piston rod, and by a piston rod, including a piston connected to the piston rod. It has proven to be particularly favorable if the piston opening and the piston rod opening have different radii.

A cover plate can be mounted on a front side and on a back side of the base body. This cover plate is used to protect the reinforcement, i.e., the cavities filled with metal foam or with the structure.

Two parallel guide receptacles, each having an inner and an outer guide surface, can be formed in the base body, each guide receptacle being assigned at least one lubrication line system, including a central line having an access opening at the surface of the base body, which is connected to an inner lubrication line and an outer lubrication line, the inner lubrication line having an inner lubrication opening which is open to the inner guide surface, and the outer lubrication line having an outer lubrication opening which is open to the outer guide surface. The guidance and the formation of the lubrication line system may take place in a variety of ways. Thus, it is also conceivable that the inner and the outer guide surfaces each have a separate access opening, a separate central line and a separate lubrication line, the lubrication line being assigned at least one lubrication opening which is open to the guide surface. In an alternative specific embodiment, it is also possible to connect the different lubrication lines to each other.

The inner lubrication line can be branched into a plurality of inner lubrication openings, and the other lubrication line is branched into a plurality of outer lubrication openings. At the same time, it has proven to be favorable if the inner lubrication line runs in parallel to the inner guide surface, and the outer lubrication line is guided in parallel to the outer guide surface. This permits an optimum, continuous lubrication of the guide surfaces, whereby the clamping force of the gripper is increased, maintenance is simplified and wear is reduced. It is furthermore favorable that a cleaning system is also formed in the base body of the second specific embodiment, which is similar to the one in the first specific embodiment.

A further embodiment comprises a clamping device, which is designed as a vise, the base body having a spindle receptacle for adjusting jaws, and at least one cavity, which runs in parallel to the spindle receptacle, is formed between the spindle receptacle and the outer wall on an underside of the base body. Alternatively, it is also possible that the base body has multiple cavities, which are separated from each other by inner walls, at least one of the cavities being filled with the reinforcement by compartmentalization (metal foam or structure). However, it is particularly preferred to fill all cavities formed in the base body with the reinforcement. Due to the formation of the cavity, the weight of the vise is also significantly reduced. The formation of the reinforcement in the cavity facilitates a high load tolerance and stability of the vise. At the same time, vibrations which occur during the use of the vise are damped and thereby transmitted to the workpiece only to a limited degree. Vibrations in the form of noise are also damped hereby, whereby little noise pollution occurs during the use of the clamping device or the vise. To protect the reinforcement against the surroundings, and to prolong the life of the vise, a cover plate is disposed on a front side of the base body.

A guide receptacle can be disposed in the spindle receptacle, which is assigned two diametrically opposed guide surfaces, each guide surface being assigned a lubrication system, including a central line which has an access opening at the surface of the base body and which is connected to a lubrication line, the lubrication line comprising a lubrication opening which is open to the guide receptacle. As a result, a continuous lubrication of the guide surfaces is achieved in the case of the vise as well, which results in a higher clamping force with less maintenance effort and little wear, i.e., a longer life.

The lubrication line can be branched in a plurality of lubrication openings, and the lubrication line is guided in parallel to the guide surface. It is furthermore favorable that a cleaning line system is also formed in the base body of the third specific embodiment, which is similar to the one in the first exemplary embodiment.

An advantage of the clamping device according to the invention is that, due to the cavities formed in the base body, a significant reduction in weight is effected, which results in an increase in performance, especially in the case of chucks, since the moment of inertia is reduced, due to the smaller mass, whereby higher rotational speeds may be reached. In that the at least one cavity has a reinforcement, i.e., a metal foam or a structure, a high stability and low weight are achieved despite the cavities. The clamping device thus has a high load tolerance, i.e., a long life. At the same time, vibrations transmitted to the base body are damped and passed on to the workpiece only to a limited degree. As a result, workpieces which are designed only for low mechanical stresses may also be processed and gripped. In that the base body is formed by an additive manufacturing process, it is possible to integrate arbitrarily running line systems into the clamping device, which achieve a continuous lubrication of the guide surfaces and a higher clamping force associated therewith. The signs of wear on the clamping device are minimized thereby and the life is prolonged. At the same time, the additional formation of a second cleaning line system results in a simplification of the maintenance work on the clamping device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows perspective view of the first specific embodiment of the clamping device according to the invention;

FIG. 2 shows a top view of the first specific embodiment;

FIG. 3 shows a section A-A of the first specific embodiment;

FIG. 3a shows a side view of the first specific embodiment;

FIG. 4 shows a section B-B of the first specific embodiment;

FIG. 4a shows a side view of the first specific embodiment;

FIG. 5 shows a section C-C of the first specific embodiment;

FIG. 6 shows a section D-D of the first specific embodiment;

FIG. 7 shows a perspective view of the second specific embodiment of the clamping device according to the invention;

FIG. 8 shows a front view of the second specific embodiment;

FIG. 9 shows a section E-E of the second specific embodiment;

FIG. 10 shows a section F-F of the second specific embodiment;

FIG. 11 shows a top view of the second specific embodiment;

FIG. 12 shows a section G-G of the second specific embodiment;

FIG. 13 shows a section H-H of the second specific embodiment;

FIG. 14 shows a section I-I of the second specific embodiment;

FIG. 15 shows a perspective view of the third specific embodiment of the clamping device according to the invention;

FIG. 16 shows a front view of the third specific embodiment;

FIG. 17 shows a top view of the third specific embodiment;

FIG. 18 shows a section K-K of the third specific embodiment;

FIG. 19 shows a section L-L of the third specific embodiment;

FIG. 20 shows a section M-M of the third specific embodiment.

### DETAILED DESCRIPTION

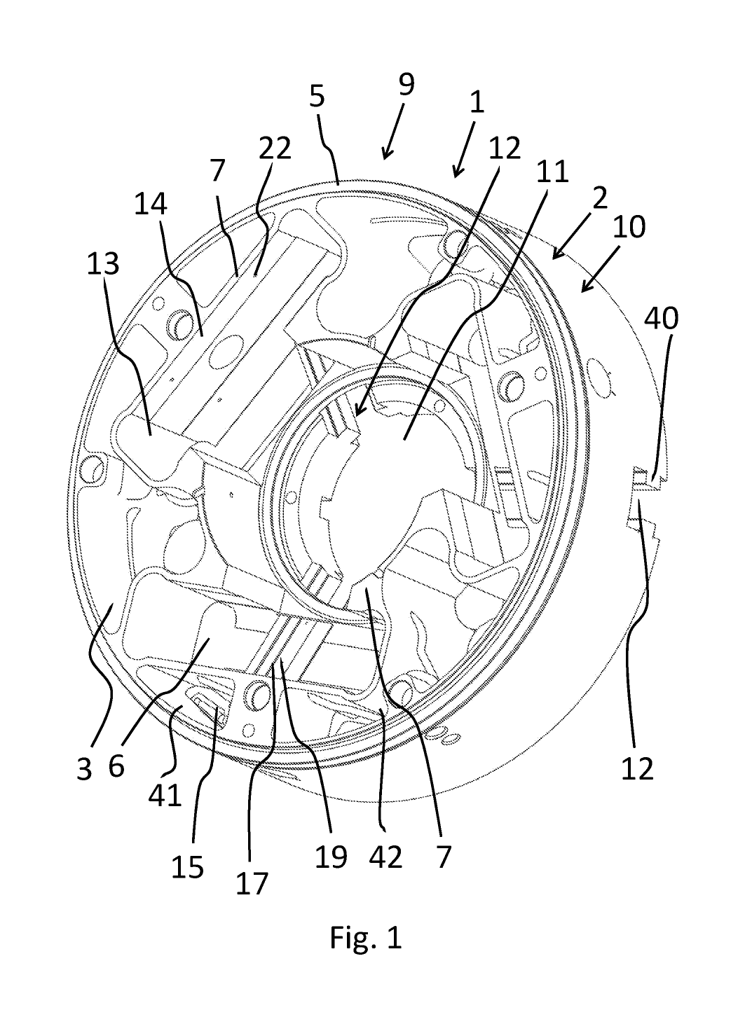

FIG. 1 shows the perspective view of the first specific embodiment of clamping device 1 according to the invention, which is designed as a chuck 9. Chuck 9 comprises a chuck body 10 as base body 2, which is surrounded by an outer wall 5 and has a passage 11 in the center. Chuck body 10 is furthermore assigned a base plate 6. Three guide receptacles 12 extend from passage 11 to outer wall 5, guide receptacles 12 being disposed distributed at regular intervals around the circumference of passage 11. Guide receptacles 12 each comprise two guide rails 40 and two diametrically opposed guide surfaces 17, along which clamping jaws may be moved. Passage 11 is surrounded by an inner wall 7. In addition, the interior of chuck body 10 is divided into multiple base structures by the formation of an inner wall (cavities 3, wedge bar receptacles 13, guide receptacles 12, passage 11 and line systems 15, 23): wedge bar receptacles 13 are disposed distributed at regular intervals around the circumference of passage 11, tangentially to guide receptacles 12. Wedge bar receptacles 13 are delimited by an inner wall and have two diametrically opposed wedge bar guide surfaces 14, along which the wedge bars may slide. Inner wall 7 between passage 11 and wedge bar receptacle 13 has an opening. This opening makes it easier to insert the wedge bars. The wedge bars are in contact with the clamping jaws, so that a movement of the wedge bars along wedge bar guide surfaces 14 results in a movement of the clamping jaws, the clamping jaws sliding radially inwardly or outwardly.

In the volume between inner wall 7 and outer wall 5, multiple cavities 3 are formed in base body 2. These cavities are filled with a reinforcement, which is not illustrated in the figures, preferably a metal foam (aluminum foam) or a structure. The arrangement of cavities 3 in chuck body 10, as well as their shape, is selected in such a way that a maximum weight reduction and a maximum load tolerance of the chuck results. Thus, a small cavity 41 and a larger cavity 42, which is separated from small cavity 41 by inner wall 7, are disposed between inner wall 7 delimiting wedge bar receptacle 13 and outer wall 5. Larger cavity 42 extends up to nearest wedge bar receptacle 13. The arrangement of cavities 3 in the chuck body is rotationally symmetrical. Chuck body 10 furthermore has a first line system 15 for lubricating guide receptacles 12 and a second line system 23 for cleaning guide receptacles 12. First line system 15 and second line system 23 run partially in outer wall 5, in inner wall 7 and in cavities 3.

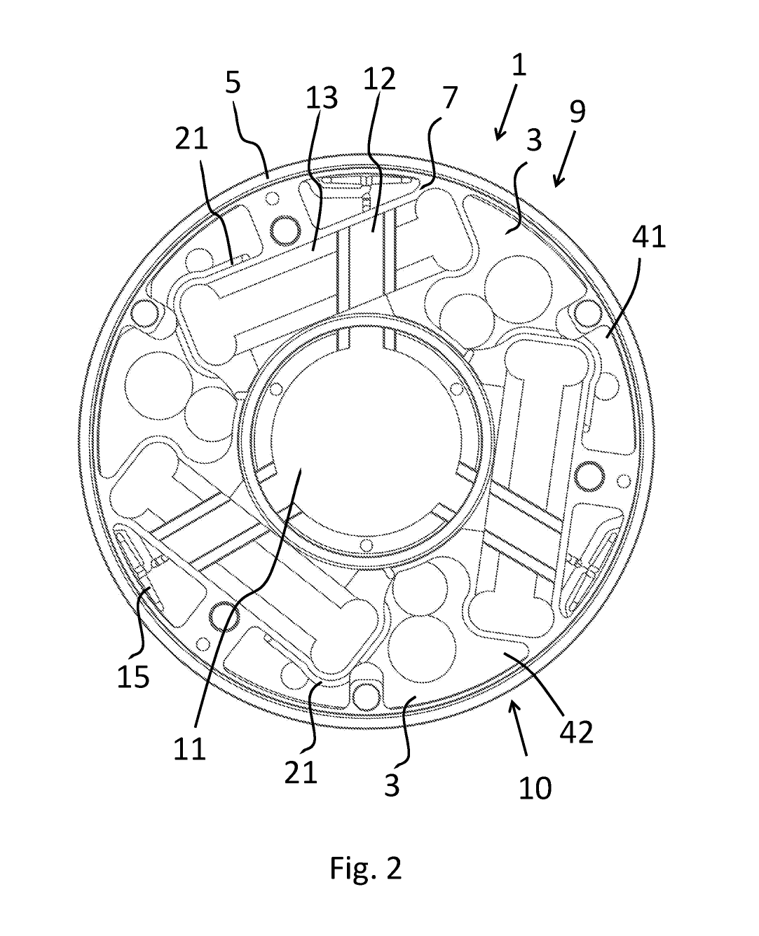

FIG. 2 shows the top view of the first specific embodiment of clamping device 1 according to the invention, it being illustrated once again here that the lines of first line system 15, i.e., feed lines 18, run partially in cavities 3, and the volume of chuck body 10 is divided into different base structures by inner wall 7.

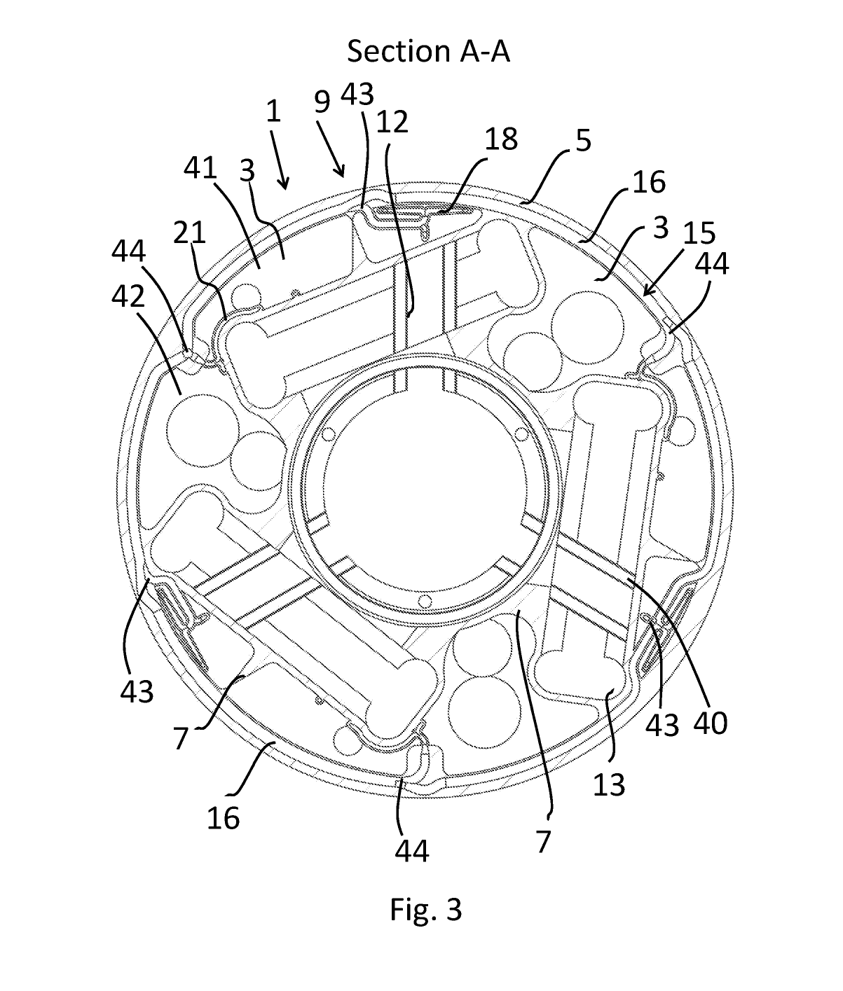

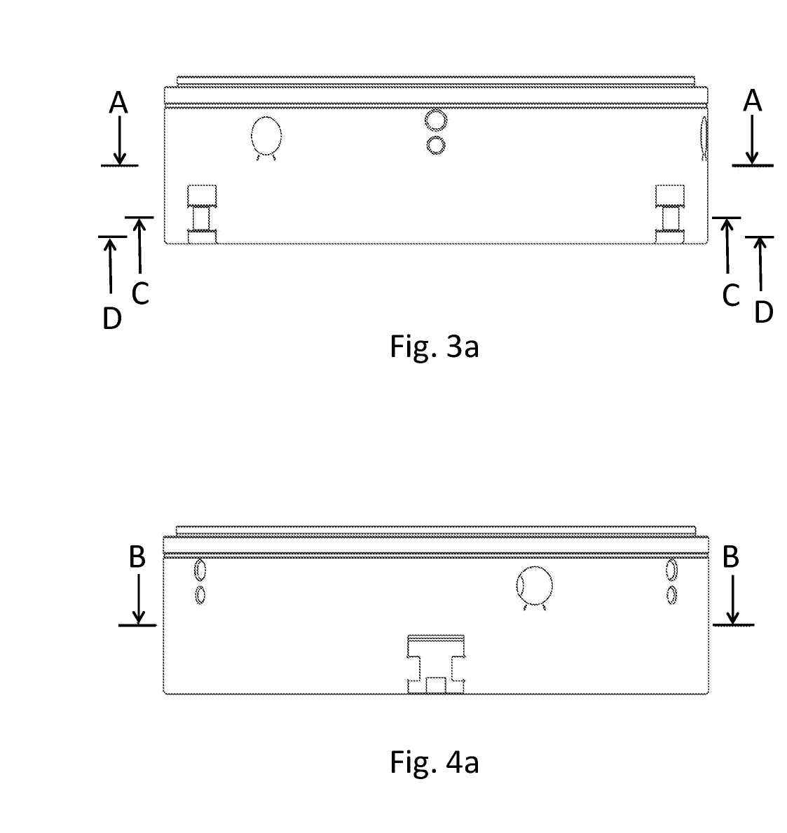

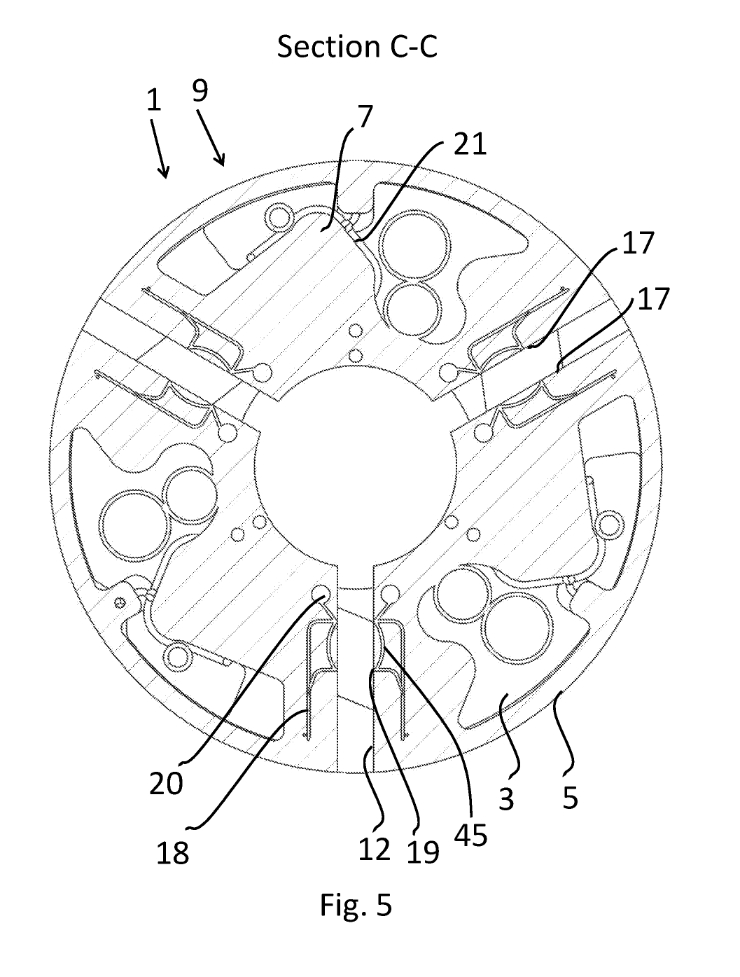

The formation of first line system 15, i.e., the lubrication line system, is illustrated in FIG. 3 and FIG. 5. First line system 15 consists of a central line 16 running along outer wall 5 in the circumferential direction. This line has three branches 43, which are distributed regularly over the circumference, from where feed lines 18 lead to the guide rails or guide surfaces 17 of guide receptacles 12. Branch 43 from central line 16 to feed line 18 takes place in small cavity 41. Feed line 18 is divided, so that one feed line is assigned to each guide rail 40 of guide receptacle 12. Feed lines 18 branch, so that two lubrication openings 19 are assigned to each guide surface 17 of guide receptacle 12. Branched feed lines 18, in turn, are connected, via a connecting line 45, to each other and to a radially inner reservoir 20. A radially inner reservoir 20, disposed in the vicinity of passage 11, is assigned to each guide surface 17. This has the advantage that, in the case of a rotating chuck 9, due to the centrifugal force, the lubricant contained in reservoir 20 is pressed outwardly into connecting line 45, whereby a continuous lubrication of guide surfaces 17 is achieved.

Central line 16 furthermore includes three rotationally symmetrically disposed connections 44, distributed evenly over the circumference, to wedge bar lubrication lines 21, which ensure that the lubricating fluid is conducted from central line 16 to wedge bar lubrication openings 22 at wedge bar guide surfaces 14 of wedge bar receptacle 13. Outer wall 5 is folded over slightly to the front at connection 44 between central line 16 and wedge bar lubrication line 21. Wedge bar lubrication line 21 runs from connection 44 through small cavity 41 or larger cavity 42, through inner wall 7, to wedge bar receptacle 13. A continuous lubrication of wedge bar guide surfaces 14 is achieved by wedge bar lubrication line 21. Reservoirs 20, feed lines 18, wedge bar lubrication lines 21 and central line 16 may be filled with lubricating fluid through a lubrication line opening at outer wall 5, which is not illustrated.

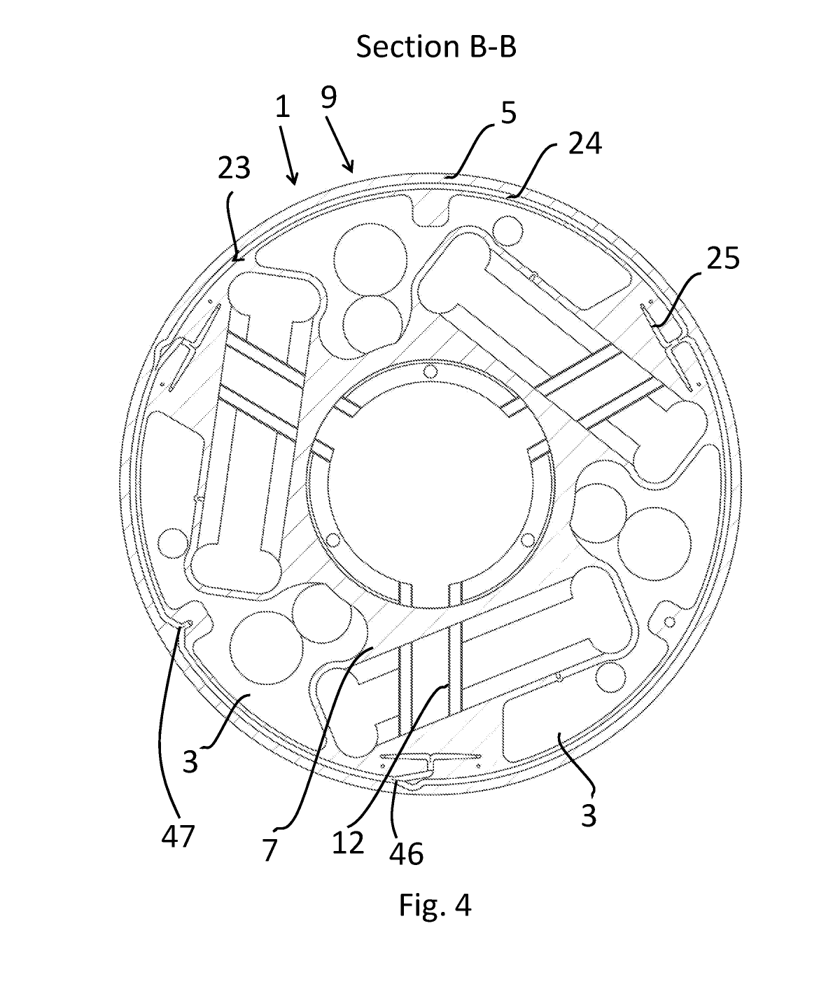

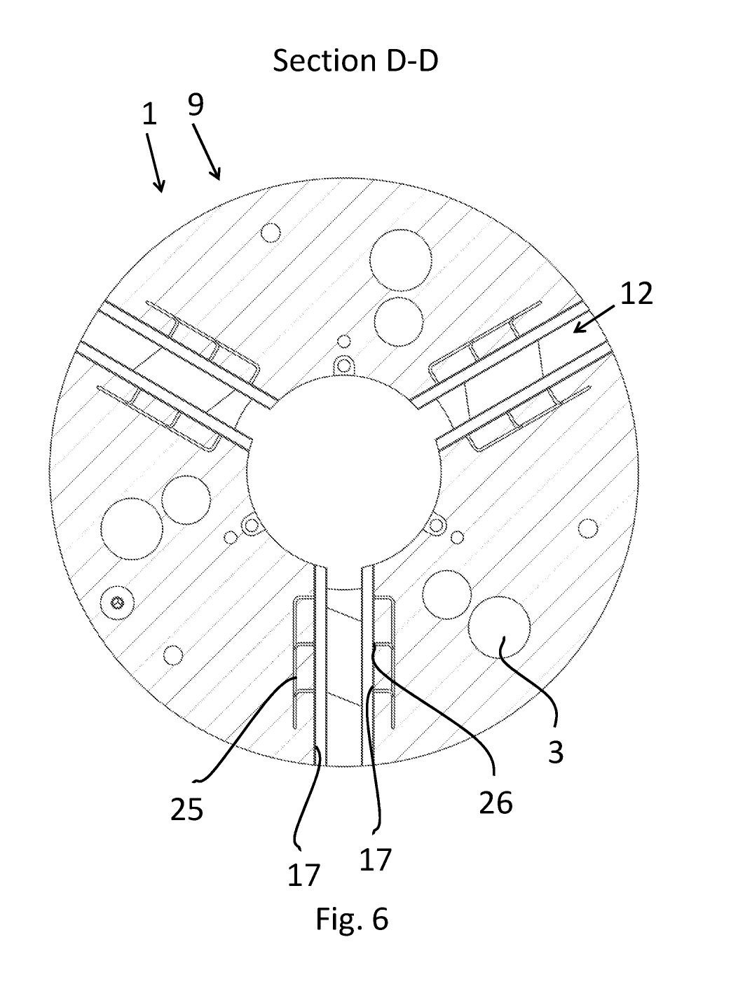

The structure of second line system 23 of the cleaning line system is illustrated in FIGS. 4 and 6. FIG. 4 shows that, similarly to first line system 15, second line system 23 has a central channel 24, which runs in the circumferential direction in outer wall 5 and also has three cleaning branches 46, distributed regularly around the circumference, and a central compressed air inlet 47. First line system 15 and second line system 23 are disposed in layers, one below the other, in different planes in chuck body 10. Cleaning branch 46 is disposed tangentially to guide receptacle 12 in inner wall 7 surrounding wedge bar receptacle 13. From there, the channel is divided in such a way that each of guide rails 40 of guide receptacles 12, or each guide surface 17, is assigned a supply channel 25, which is divided into three cleaning openings 26. Cleaning openings 26 are oriented tangentially to chuck 9 or perpendicularly to guide surface 17. Similarly to connection 44 of first line system 15, compressed air inlet 47 is disposed in the folded-over areas of outer wall 5. Channels, which are not shown in the drawing, lead from there to compressed air inlet 47. Second line system 23 (preferably for compressed air) is used to preferably easily clean guide surfaces 17 and guide receptacles 12, so that the maintenance of the chuck is simplified.

It is also apparent from FIG. 3, compared to FIG. 4, that the 3-dimensional shape of cavities 3 changes in the different planes of intersection of chuck 9. An inner wall 7 is thus formed at the point in FIG. 4 at which cleaning branch 46 is situated, while a cavity 3 is formed at the same point in FIG. 3.

Chuck 9 is manufactured using an additive manufacturing method, preferably by laser beam melting. A 3D model of chuck 9 is created, which already comprises all relevant basic structures, i.e., guide receptacles 12, passage 11, outer wall 5, base plate 6, inner wall 7, wedge bar receptacles 13, first line system 15, second line system 23 and their shape as well as arrangement in the chuck body. The additive manufacturing method makes it possible to dispose, in particular, line systems 15, 23 and cavities 3 individually in chuck 9 and to adapt the structure of chuck 9 to individual requirements. Chuck 9 is then created in layers from tool steel or titanium on the basis of the 3D model, using laser beam melting. In a next step, cavities 3 formed between inner wall 7 and outer wall 5 of chuck 9 are filled with a metal foam as the reinforcement by compartmentalization. For this purpose, flakes made from aluminum and titanium hydride are filled into cavities 3, aluminum foam being produced by heating chuck body 10 to a temperature of approximately 500°. In another step, the surface of chuck 9 may be processed in such a way that it forms a smooth, even surface. Alternatively to the metal foam, in the first step, a structure, e.g., a honeycomb structure, may be integrated as the reinforcement into cavities 3 between inner wall 7 and other wall 5. This means that the 3D model already contains a structure in cavities 3, and consequently the structure may already be produced along with the other basic structures of chuck 9 during the additive manufacturing process. Filling cavities 3 with a reinforcement provides the advantage that cavities 3 are additionally stabilized, i.e., the load tolerance is increased. At the same time, the weight of chuck 9 according to the invention is significantly lower due to the pores of the metal foam or the structure in cavities 3.

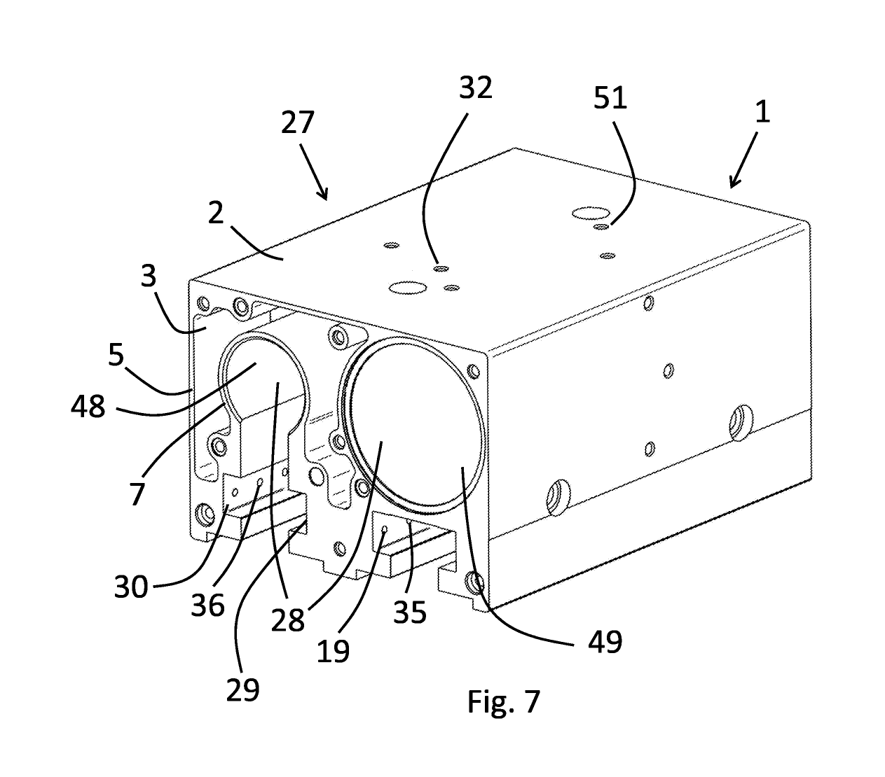

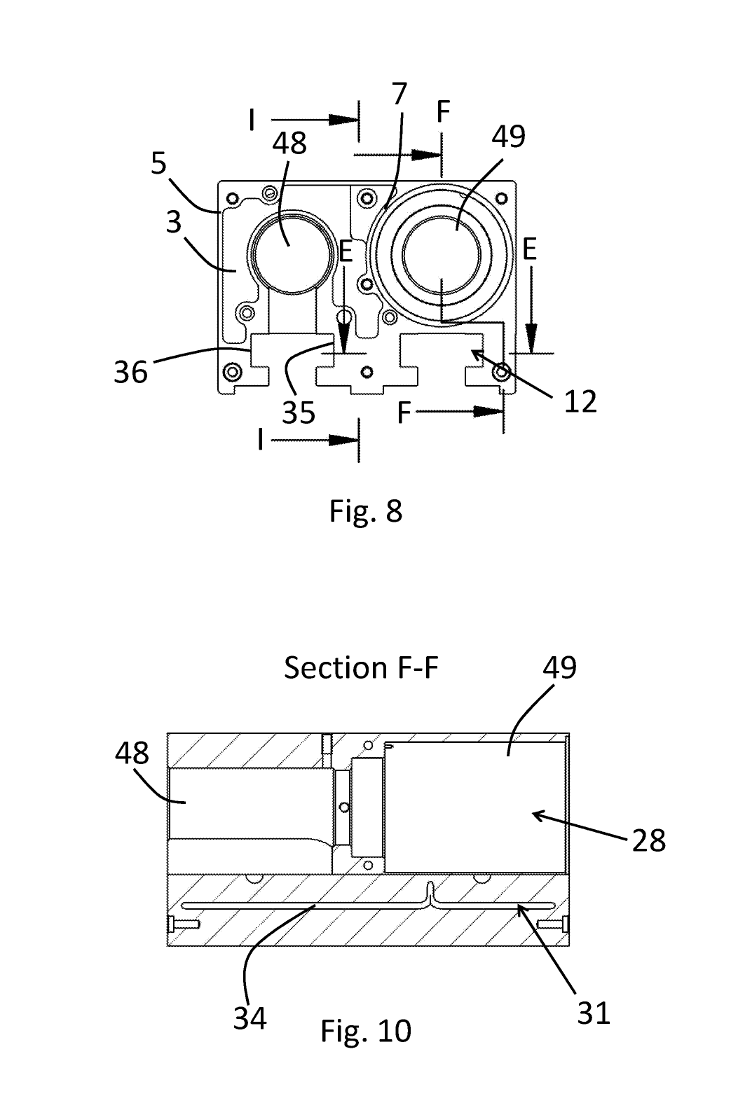

FIG. 7 shows the perspective view of a second specific embodiment of clamping device 1 according to the invention, which is designed as a gripper 27. Gripper 27 comprises a cuboid base body 2, which has an outer wall 5, two parallel guide receptacles 12 and two cylinder chambers 28 running in parallel to guide receptacles 12. Guide receptacles 12 each have an inner guide surface 29 and an outer guide surface 30. Each cylinder chamber 28 is formed from a piston rod opening 48, including a piston rod, and from a piston opening 49, including a piston connected to the piston rod. It is apparent from FIG. 7 that, viewed from the front side of base body 2, the course of cylinder chamber 28 first includes piston rod opening 48 and then piston opening 49, while the second course of cylinder chamber 28 first includes piston opening 49 and then piston rod opening 48. The radius of piston rod opening 48 is smaller than the radius of piston opening 49. A gripper jaw, which is not illustrated, is assigned to each guide receptacle 12, the gripper jaws being displaceable by the piston. FIG. 7 also shows that piston rod opening 48 is delimited by an inner wall 7 on the front side, a cavity 3 being formed between outer wall 5 and inner wall 7. A cavity 3 is also formed on the back side of gripper 27, which is not illustrated, between inner wall 7 delimiting piston rod opening 48 and outer wall 5 of base body 2. Cavities 3 each extend inside base body 2 up to the point at which piston rod opening 48 transitions into a piston opening 49. This is illustrated, in particular, in FIG. 10. Cavities 3 have a reinforcement (metal foam or structure), whereby a low weight of gripper 27 and a high load tolerance are achieved.

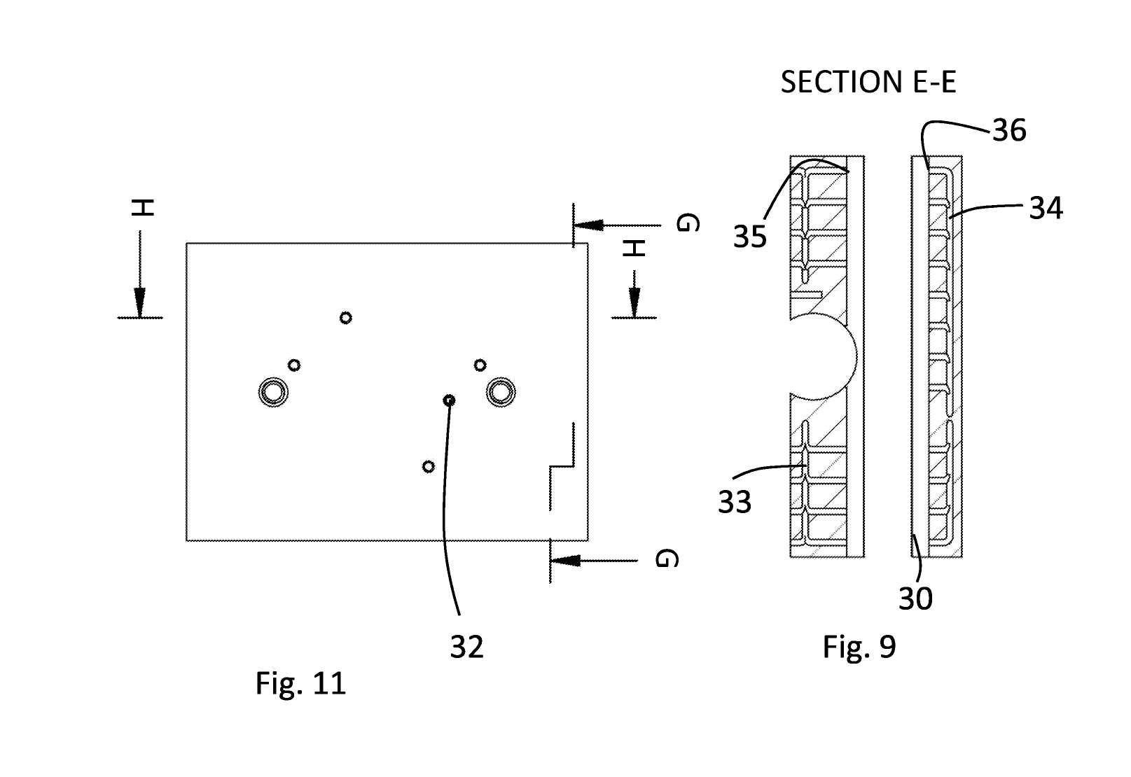

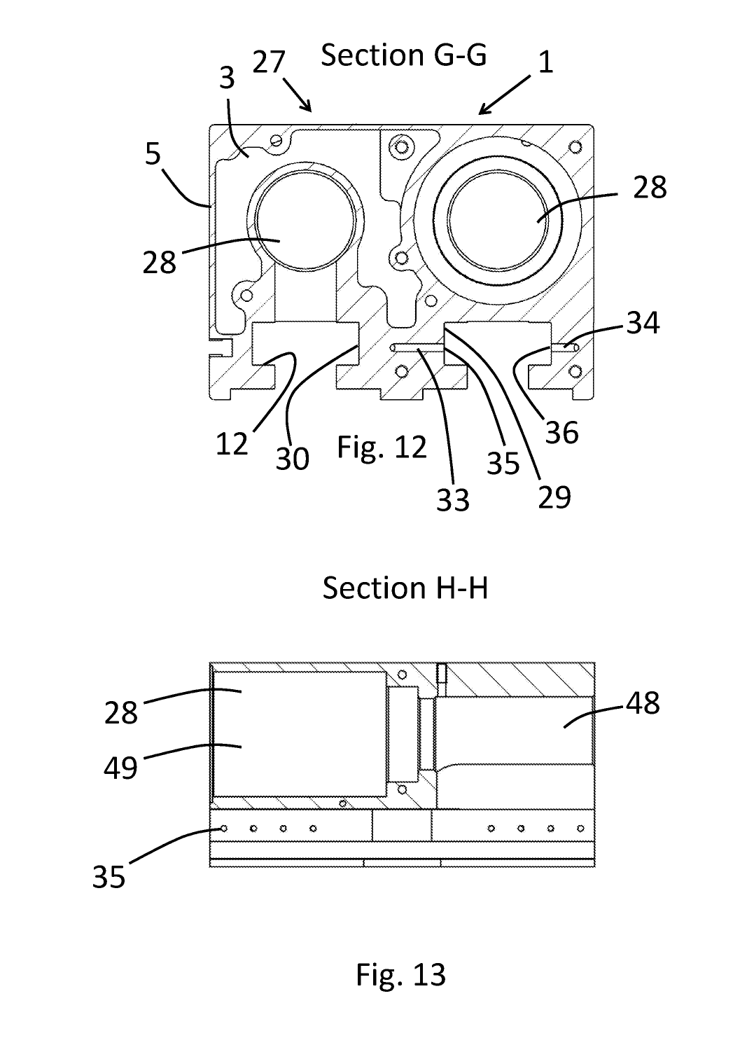

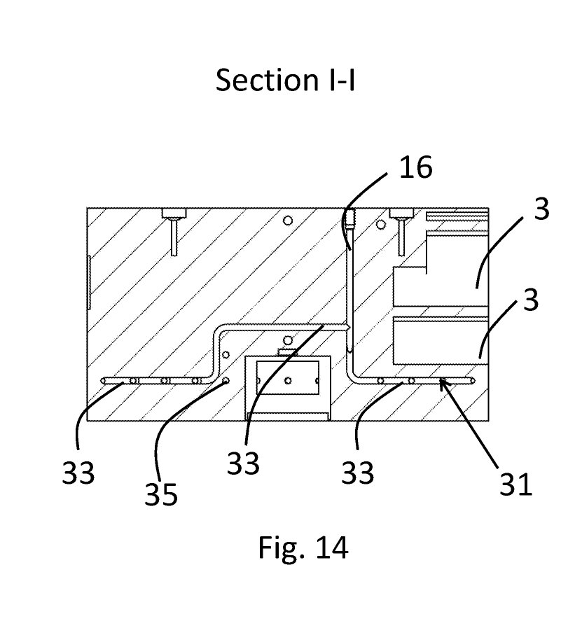

A lubrication line system 31 formed in base body 2 is described in FIGS. 9 through 14. A lubrication line system 31 is thus assigned to each guide receptacle 12, this lubrication line system consisting of an access opening 32 on the upper side of base body 2, from which a central line 16 leads in the direction of guide receptacles 12. Central line 16 branches to an inner lubrication line 33, which runs in parallel along inner guide surface 29, and to an outer lubrication line 34, which runs in parallel to outer guide surface 30. Outer lubrication line 34 and inner lubrication line 33 branch multiple times, so that a plurality of inner lubrication openings 35 and outer lubrication openings 36 are formed tangentially to inner guide surface 29 and outer guide surface 30. In this manner, a continuous lubrication of inner guide surfaces 29 and outer guide surfaces 30 of guide receptacle 12 is facilitated. FIG. 12 shows lubrication openings 35, 36 along guide surfaces 29, 30. Outer lubrication openings 36 of outer guide surfaces 30 are connected to central line 16 via outer lubrication line 34. Each guide receptacle 12 has a lubrication line system 31, including eight inner lubrication openings 35 and twelve outer lubrication openings 36.

Gripper 27 is also manufactured using an additive manufacturing process, laser beam melting, in that a 3D model of base body 2 is produced. This 3D model comprises the structure, the arrangement and the formation of cylinder chambers 28, piston rod openings 48, piston openings 49, guide receptacles 12, lubrication line systems 31 of the second line system, outer walls 5, inner wall 7, cavities 3 and the additional line systems which are necessary for the pneumatic operation of the gripper jaws. In a next step, base body 2 is produced in layers on the basis of the 3D model, using laser melting. In a next step, the reinforcement are formed in cavities 3. For this purpose, flakes made from aluminum and titanium hydride are filled into cavities 3, aluminum foam being produced by heating base body 2 to a temperature of approximately 500°. Cavities 3 filled with metal foam may be processed subsequently, so that the surfaces are smoothed. In a final step, a cover plate is mounted on the front side and the back side of base body 2 for protection. Alternatively to the metal foam, a structure, e.g., a honeycomb structure, ma be formed in cavities 3. This structure may be integrated directly into the 3D model, so that the reinforcement structure, that is, for example the honeycomb structure, is produced simultaneously with the rest of the gripper during the manufacture of gripper 27 on the basis of the 3D model.

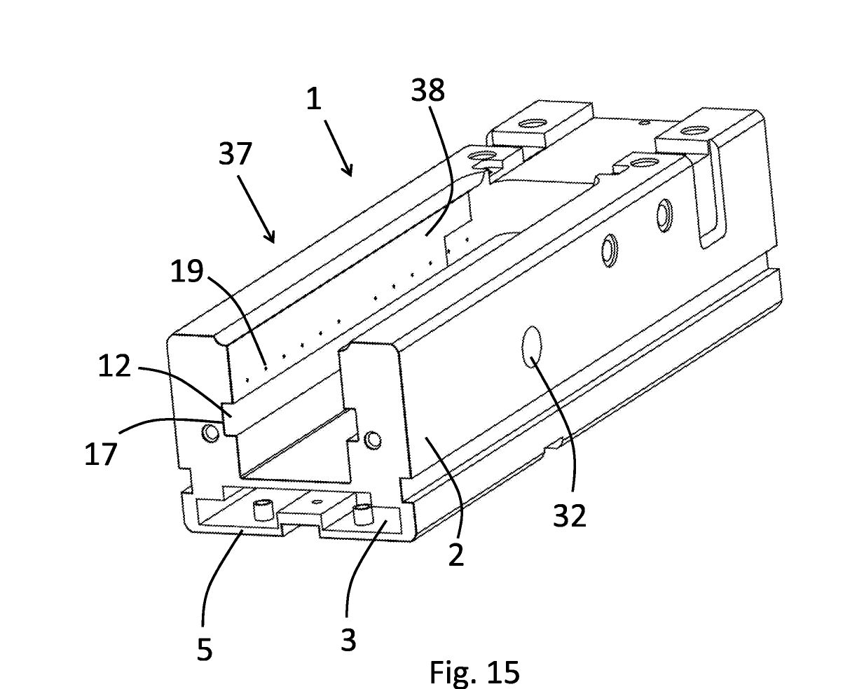

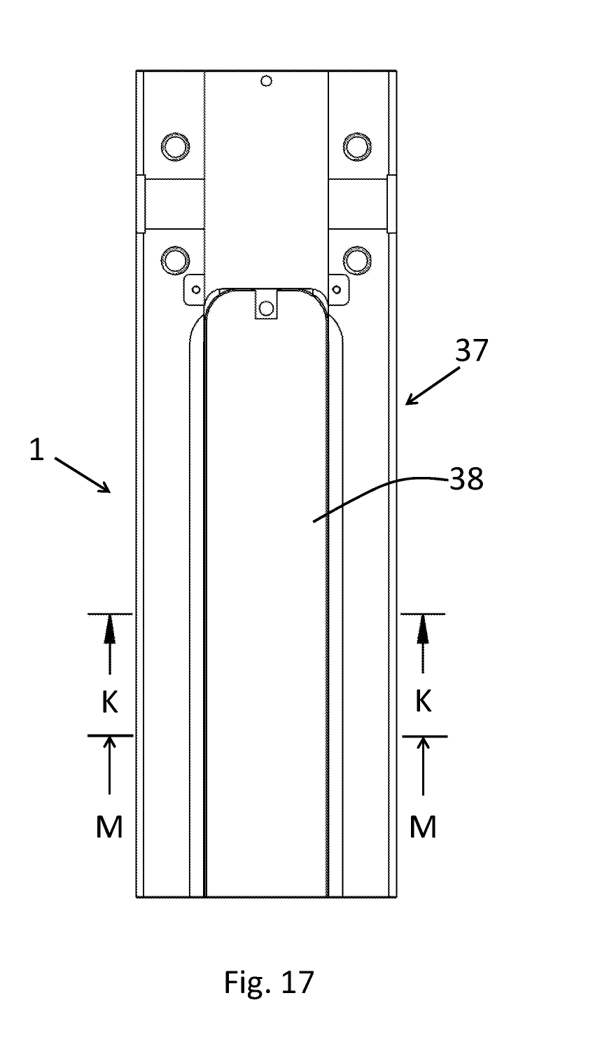

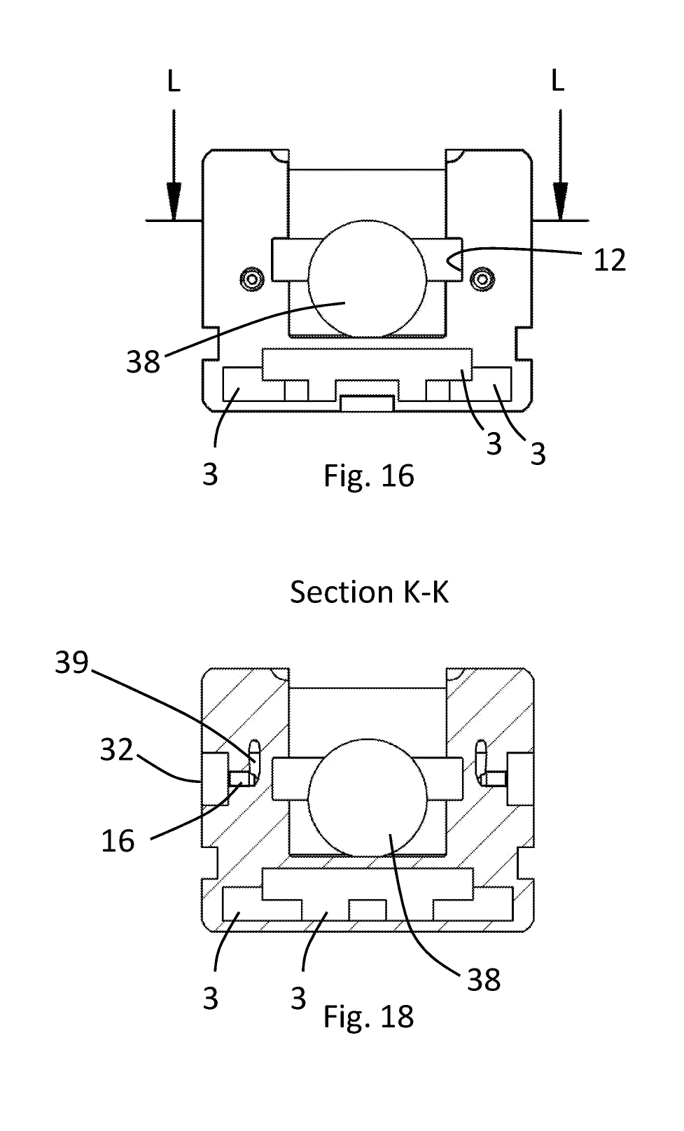

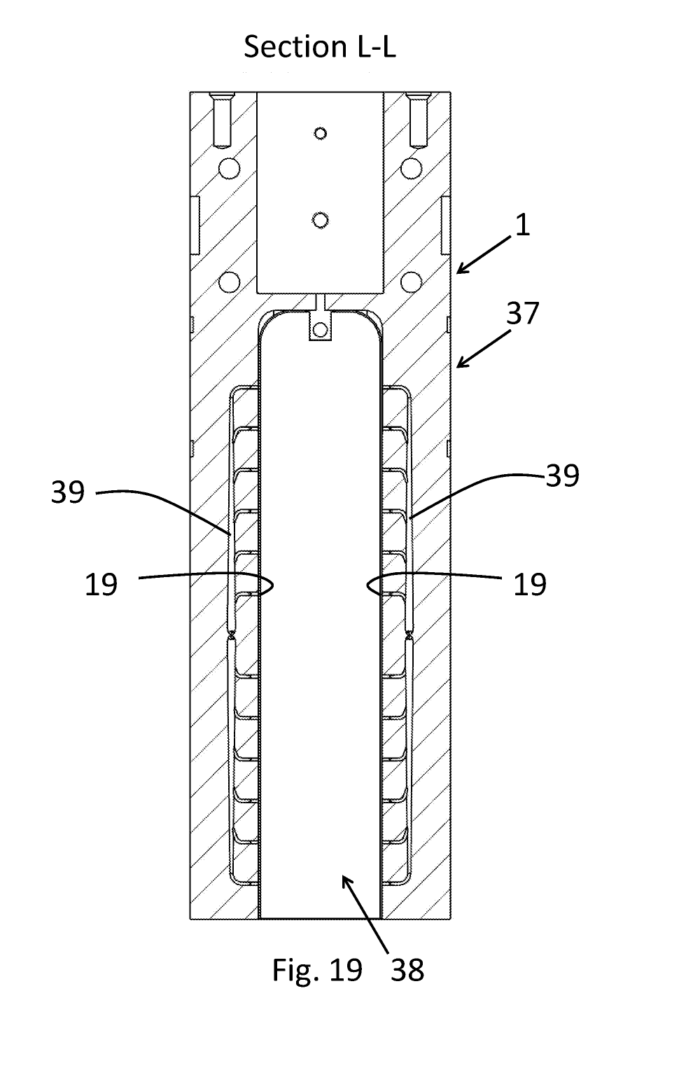

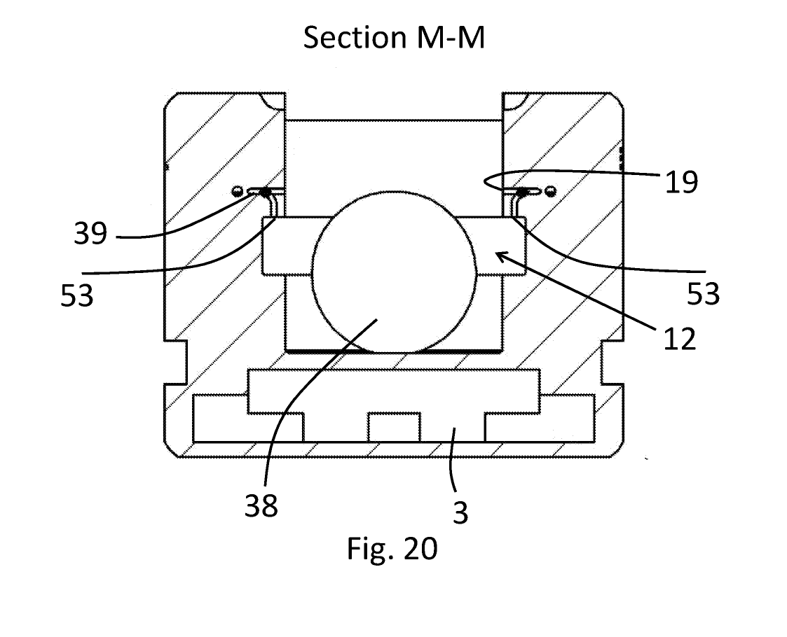

FIG. 15 shows the perspective view of the third specific embodiment of clamping device 1 according to the invention, which is designed as a vise 37. Vise 37 has a base body 2, including a spindle receptacle 38, spindle receptacle 38 comprising a guide receptacle 12, including two guide rails 40, and two diametrically opposed guide surfaces 17. A jaw, which is not illustrated, may be attached to the spindle, which is not illustrated in FIG. 15, in spindle receptacle 38. Spindle receptacle 38 is disposed in a non-continuous manner in base body 2, so that base body 2 has a stationary base jaw, which is not illustrated in FIG. 15. By the movement of the spindle, the movable jaw, which is in contact with the spindle, may be moved against the stationary jaw for the purpose of clamping a workpiece. Base body 2 is surrounded externally by an outer wall 5, while spindle receptacle 38 is surrounded by an inner wall 7. FIG. 16 shows a front view of the vise, a cavity 3, which runs in parallel to spindle receptacle 38, is formed between outer wall 5 and inner wall 7 on the underside of base body 2. Cavity 3 extends up to the end of spindle receptacle 38. Cavity 3 is filled with a reinforcement by compartmentalization, i.e., the cavity includes either a metal foam or a structure. It is apparent from FIG. 18 and FIG. 19 that a lubrication line system 31 is assigned to each guide surface 17, an access opening 32 being formed on each side of the surface of base body 2. This opening is connected to a central line 16, which leads to a lubrication line 39, which runs in parallel to guide surface 17 in base body 2. Access opening 32 and central line 16 are disposed in the center of base body 2, so that lubrication line 39 runs on the right and left along guide surface 17, viewed from central line 16. Lubrication lines 39 have multiple branches, the branches each having a guide lubrication opening 50, which opens in the direction of the guide receptacle, and a lubrication opening 19, which opens tangentially to spindle receptacle 38. A continuous lubrication of spindle receptacle 38 and guide receptacle 12 is possible thereby.

Similarly to the other exemplary embodiments, vise 37 is manufactured in that a 3D model of base body 2 is created in a first step, which comprises outer wall 5, inner wall 7, spindle receptacle 38, guide receptacles 12, lubrication line systems 31 and cavity 3. In a next step, base body 2 is produced in layers from metal on the basis of the 3D model, using laser melting. In the next step, flakes made from aluminum and titanium hydride are filled into cavities 3, aluminum foam being produced by heating the base body to a temperature of approximately 500°. Optionally, the surface may be leveled on the front of vise 37, and a cover plate may be attached for protection. Alternatively to the metal foam, a structure, e.g., a honeycomb structure, may be formed in cavity 3. This structure may be integrated directly into the 3D model, so that the reinforcement structure, that is, for example the honeycomb structure, is produced simultaneously with the rest of the vise during the manufacture of vise 37 on the basis of the 3D model.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A clamping device for clamping a workpiece, the clamping device comprising:
a base body;
at least one clamping that is adjustable relative to the base body;
at least one cavity formed in the base body; and
a reinforcement formed in the cavity.

2. The clamping device according to claim 1, wherein the base body is formed in layers by a generative process.

3. The clamping device according to claim 1, wherein the base body is delimited on an edge by an outer wall and has a base plate, on which an inner wall is arranged for delimiting the at least one cavity.

4. The clamping device according to claim 1, wherein the reinforcement is formed by a metal foam.

5. The clamping device according to claim 4, wherein the metal foam is formed from a foaming agent-activatable metal powder, the metal powder being selected from the group of aluminum, aluminum alloys, copper, zinc, lead, steel, titanium and/or iron.

6. The clamping device according to claim 3, wherein the reinforcement is formed by a structure connected to the inner wall.

7. The clamping device according to claim 1, wherein the base body is designed as a chuck, including a spindle receptacle and including at least two guide receptacles, which are evenly distributed over the circumference and are delimited by the inner wall for adjusting clamping jaws, and wherein the at least one cavity is formed between the outer wall and the inner wall.

8. The clamping device according to claim 7, wherein two diametrically opposed guide surfaces are assigned to each guide receptacle, wherein the chuck body comprises a first line system for lubrication, including a central line running in the circumferential direction, each guide surface assigned a feed line that is connected to the central line and has a lubrication opening that is open in the direction of the guide receptacle.

9. The clamping device according to claim 8, wherein the feed line is branched into a plurality of lubrication openings.

10. The clamping device according to claim 8, wherein a radially inner reservoir, which is connected to the feed line, is assigned to each guide surface.

11. The clamping device according to claim 10, wherein a lubricating fluid is provided, which is situated in the reservoirs and is pressable radially outwardly on the basis of the centrifugal force via the feed line to the lubrication opening for automatic lubrication of the guide receptacles.

12. The clamping device according to claim 8, wherein each guide receptacle is tangentially assigned a wedge bar receptacle, including a wedge bar, which is delimited by the inner wall and is movable along two diametrically opposed wedge bar guide surfaces, each wedge bar receptacle assigned a wedge bar lubrication line, which is connected to the central line and has at least one wedge bar lubrication opening, which is open in the direction of the wedge bar receptacle.

13. The clamping device according to claim 7, wherein the chuck body comprises a second line system for cleaning, including a central channel running in the circumferential direction, each guide surface assigned one supply channel, which is connected to the central channel and has a cleaning opening, which opens in the direction of the guide receptacle.

14. The clamping device according to claim 13, wherein the supply channel is branched into a plurality of cleaning openings.

15. The clamping device according to claim 1, wherein the base body has a cuboid shape, including cylinder chambers, which are formed in the base body and are delimited by an inner wall, and the at least one cavity is disposed between the outer wall and the inner wall.

16. The clamping device according to claim 15, wherein two parallel guide receptacles, each having an inner guide surface and an outer guide surface, are formed in the base body, each guide receptacle assigned at least one lubrication line system including a central line, which has an access opening at the surface of the base body and is connected to an inner lubrication line and an outer lubrication line, the inner lubrication line having an inner lubrication opening that is open to the inner guide surface, and the outer lubrication line having an outer lubrication opening that is open to the outer guide surface.

17. The clamping device according to claim 1, wherein the base body has a spindle receptacle for adjusting jaws, and at least one cavity extending parallel to the spindle receptacle is formed between the spindle receptacle and the outer wall on an underside of the base body.

18. The clamping device according to claim 17, wherein a guide receptacle is disposed in the spindle receptacle, which is assigned two diametrically opposed guide surfaces, each guide surface is assigned a lubrication line system, including a central line, which has an access opening at the surface of the base body and which is connected to a lubrication line, the lubrication line having a lubrication opening that is open to the guide receptacle.
